(19) United States
(12) Patent Application Publication
(10) Pub. No.: US 2024/0195709 A1
(43) Pub. Date: Jun. 13, 2024

(54) METHOD AND SYSTEM FOR PROVIDING WIRELESS COMMUNICATION NETWORK ASSURANCE

(71) Applicant: SAMSUNG ELECTRONICS CO., LTD., Suwon-si, Gyeonggi-do (KR)

(72) Inventor: Deepanshu GAUTAM, Bangalore (IN)

(21) Appl. No.: 18/553,962

(22) PCT Filed: Mar. 30, 2022
(86) PCT No.: PCT/KR2022/004523

§ 371 Date: Oct. 4, 2023

(30) Foreign Application Priority Data
Apr. 6, 2021 (IN) 202141016129
Mar. 15, 2022 (IN) 202141016129

(51) Int. Cl. H04L 41/5025; H04W 24/02; H04W 84/04

(52) U.S. Cl. CPC H04L 41/5025; H04W 24/02; H04W 84/042

(57) ABSTRACT

The disclosure relates to a 5G or 6G communication system for supporting a higher data transmission rate. The present disclosure relates to a method and an Assurance Closed Control Loop (ACCL) system (101) for providing wireless communication network assurance. The method comprises receiving one or more assurance goals targeted for at least one of, one or more target locations and one or more target User Equipments (UEs). The one or more assurance goals are configured for an ACCL. Further, the method comprises monitoring a wireless communication network (102) based on the one or more assurance goals configured for the ACCL. Furthermore, the method comprises determining whether the one or more assurance goals are complied based on the monitoring.

### TECHNICAL FIELD

The present disclosure generally relates to the field of communication networks. More particularly, the present disclosure relates to a method and a system for providing wireless communication network assurance.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

Wireless communication networks provide different communication services to users. The wireless communication networks aim to meet certain Key Performance Indicator (KPI)s that may be required by emerging applications. For example, the wireless communication network may be a Fifth Generation (5G) network. The 5G network aims to meet network requirements such as, data rate, reliability, latency, communication range, speed, and the like. In an example, Vehicle to Everything (V2X) services provided by the 5G network must meet stringent network requirements. Further, network operators use network slicing to provide the communication services which require similar network characteristics to different vertical industries. Network slices provided for different services must meet various network requirements. It is required to monitor network health and network requirements of the wireless communication network.

Assurance Closed Control Loop (ACCL) may monitor the network health and the network requirements. The ACCL is fully automated and there is no direct involvement of a human operator or other management entity. The human operator or the other management entity configures assurance goals for the ACCL to monitor the network health and the network requirements. The ACCL monitors the wireless communication network based on the assurance goals and ascertains whether the assurance goals are being breached. When an assurance goal is breached, the ACCL performs mitigation actions.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE OF INVENTION

### Technical Problem

Conventional ACCL lacks ability to enable targeted ACCL deployment. The conventional ACCL is configured with the assurance goals (for example, guaranteed throughput per slice), from service profile or slice profile, to ensure for the communication services offered by the wireless communication networks. However, it is not possible to configure targeted assurance goals. For instance, it is not possible to configure guaranteed throughput per slice for a particular location and/or for a particular User Equipment (UE).

### Solution to Problem

In an embodiment, the present disclosure discloses a method of providing wireless communication network assurance. The method comprises receiving one or more assurance goals targeted for at least one of, one or more target locations and one or more target user equipments (UEs). The one or more assurance goals are configured for an ACCL. Further, the method comprises monitoring a wireless communication network based on the one or more assurance goals configured for the ACCL. Furthermore, the method comprises determining whether the one or more assurance goals are complied, based on the monitoring.

In an embodiment, the present disclosure discloses a system for providing wireless communication network assurance. The system comprises a processor and memory. The processor is configured to receive one or more assurance goals targeted for at least one of, one or more target locations and one or more target user equipments (UEs). The one or more assurance goals are configured for an ACCL. Further, the processor is configured to monitor a wireless communication network based on the one or more assurance goals configured for the ACCL. Furthermore, the processor is configured to determine whether the one or more assurance goals are complied, based on the monitoring.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an exemplary environment for providing wireless communication network assurance, in accordance with some embodiments of the present disclosure;

FIG. 2 illustrates a detailed diagram of an ACCL system for providing the wireless communication network assurance, in accordance with some embodiments of the present disclosure;

FIG. 3 shows an exemplary flow chart illustrating method steps for providing the wireless communication network assurance, in accordance with some embodiments of the present disclosure;

FIG. 4 shows an exemplary sequence diagram illustrating steps for providing the wireless communication network assurance, in accordance with some embodiments of the present disclosure; and

FIG. 5 illustrates a block diagram of an exemplary computer system for providing the wireless communication network assurance, in accordance with some embodiments of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### MODE FOR THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Wireless communication network aims to meet various network requirements for providing reliable and efficient communication services to users. For example, the network requirements may include data rate, reliability, latency, communication range, speed, and the like.

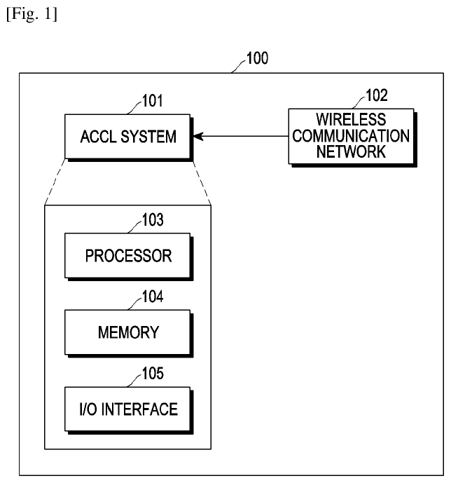

Assurance Closed Control Loop (ACCL) is used to monitor network health and the network requirements of the wireless communication network. The ACCL monitors the wireless communication network based on assurance goals and ascertains whether the assurance goals are being breached. The present disclosure provides methods and systems for targeted ACCL deployment. The assurance goals targeted for one or more locations and/or one or more User Equipments (UEs) are configured in the ACCL. Hence, the present disclosure allows targeted assurance for particular locations/UEs. FIG. 1 illustrates an exemplary environment 100 for providing wireless communication network assurance, in accordance with some embodiments of the present disclosure.

Referred to FIG. 1, the exemplary environment 100 may comprise an Assurance Closed Control Loop (ACCL) system 101 and a wireless communication network 102. The ACCL system 101 may monitor the network health and network requirements of the wireless communication network 102. The ACCL system 101 may be fully automated and there is no direct involvement of a human operator or other management entity. The ACCL system 101 may receive data related to the wireless communication network 102. For example, the data related to the wireless communication network 102 may include measurement data of one or more parameters associated with the wireless communication network 102. The ACCL system 101 may monitor the wireless communication network 102 based on configured assurance goals and the data related to the wireless communication network 102. In an embodiment, the ACCL system 101 may aim to achieve a stable networking environment with minimal human intervention.

In an embodiment, the wireless communication network 102 may include a Fifth Generation (5G) network, a Fourth Generation (4G) network, and the like. In another embodiment, the wireless communication network 102 may include a network slice, a network slice subnet, a network function, and the like. A person skilled in the art will appreciate that the wireless communication network 102 may include other kinds of networks and is not limited to the above-mentioned networks.

In an embodiment, the ACCL system 101 may be configured with one or more assurance goals targeted for at least one of, one or more target locations and one or more target user equipments (UEs). Firstly, the ACCL system 101 may receive the one or more assurance goals targeted for at least one of, the one or more target locations and the one or more target User Equipments (UEs). For example, when the assurance goal is targeted for a UE, the assurance goal may include for instance a bandwidth of a network slice used by the UE. The one or more assurance goals are configured for an ACCL by a management entity. For example, the management entity may be a network operator. Then, the ACCL system 101 may monitor the wireless communication network 102 based on the one or more assurance goals configured for the ACCL. The ACCL system 101 determines whether the one or more assurance goals are complied, based on the monitoring.

The ACCL system 101 may include Central Processing Units 103 (also referred as “CPUs” or “a processor 103”), a memory 104, and an Input/Output (I/O) interface 105. In some embodiments, the memory 104 may be communicatively coupled to the processor 103. The memory 104 stores instructions executable by the processor 103. The processor 103 may comprise at least one data processor for executing program components for executing user or system-generated requests. The memory 104 may be communicatively coupled to the processor 103. The memory 104 stores instructions, executable by the processor 103, which, on execution, may cause the processor 103 to provide the wireless communication network assurance.

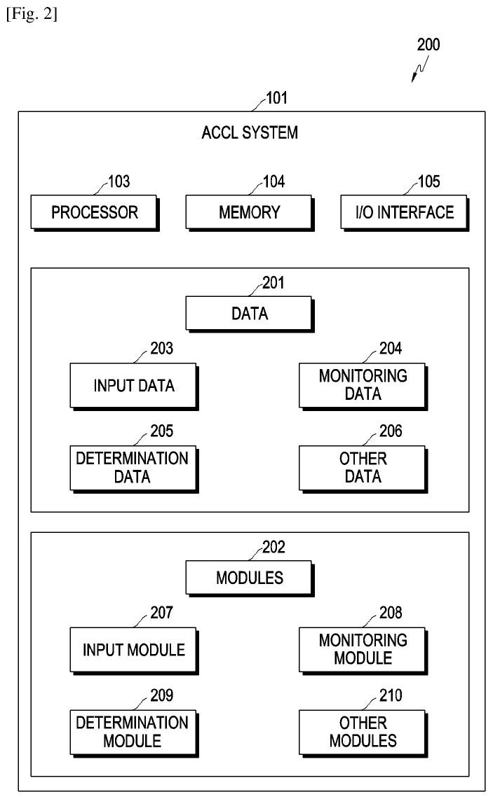

FIG. 2 illustrates a detailed diagram 200 of the ACCL system 101 for providing the wireless communication network assurance, in accordance with some embodiments of the present disclosure.

Referred to FIG. 2, the ACCL system 101 may comprise the processor 103, the memory 104, and the I/O interface 105, In an embodiment, the memory 104 may include one or more modules 202 and data 201. The one or more modules 202 may be configured to perform the steps of the present disclosure using the data 201, to provide the wireless communication network assurance.

In an embodiment, each of the one or more modules 202 may be a hardware unit which may be outside the memory 104 and coupled with the ACCL system 101. As used herein, the term modules 202 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 202 when configured with the described functionality defined in the present disclosure will result in a novel hardware.

The I/O interface 105 is coupled with the processor 103 through which an input signal or/and an output signal is communicated. For example, the ACCL system 101 may receive the one or more assurance goals from an ACCL consumer via the I/O interface 105.

In one implementation, the modules 202 may include, for example, an input module 207, a monitoring module 208, a determination module 209, and other modules 210. It will be appreciated that such aforementioned modules 202 may be represented as a single module or a combination of different modules. In one implementation, the data 201 may include, for example, input data 203, monitoring data 204, determination data 205, and other data 206.

In an embodiment, the input module 207 may be configured to receive the one or more assurance goals targeted for at least one of, the one or more target locations and the one or more target UEs. The one or more assurance goals are received from an ACCL consumer. The ACCL consumer may be Operations, Administration And Management (OAM) entity. For example, the ACCL consumer may be a network operator. The one or more assurance goals may comprise one or more pre-defined attributes for the wireless communication network 102. For example, if the wireless communication network 102 is a network slice, the one or more pre-defined attributes for the network slice may include bandwidth, throughput, latency, maximum number of users allocated to the network slice, and the like.

The ACCL consumer may receive a requirement of configuring the one or more assurance goals for at least one of, the one or more target locations and the one or more target UEs. For example, consider an event is organized in a location A. The ACCL consumer may receive the requirement to provide high data rate and reliable services in the location A. Firstly, the ACCL consumer may identify assurance goals from service profile or slice profile. Service profile is defined in 3GPP TS 28.541. Further, the ACCL consumer may identify the one or more assurance goals for the location A. The one or more assurance goals may comprise, a throughput value, a data rate value, a latency value, and the like.

In an embodiment, the one or more assurance goals may comprise desired values or threshold values associated with the one or more pre-defined attributes. For example, the one or more assurance goals may comprise a minimum value of throughput, a minimum value of data rate, a maximum value of latency, and the like. In another example, the ACCL consumer may configure the one or more assurance goals for the one or more UE's based on requirement from the one or more UEs. The one or more UEs may be part of a mission-critical service. High data speed and low latency may be required by the one or more UEs. In another example, a Very Important Person (VIP) may be arriving at a particular location in a city. The one or more assurance goals may be configured for the location and localities around the locations.

In an embodiment, the ACCL consumer may configure the one or more assurance goals for a single or multiple locations irrespective of UEs, for a single or multiple UEs irrespective of location, and for a single or multiple UEs in a particular location. In an embodiment, the one or more assurance goals for at least one of, the one or more target locations and the one or more target UEs may be configured in the ACCL as shown in the Table 1 below. The one or more assurance goals may be stored as the input data 203 in the memory 104.

TABLE 1

| Attributes Name | Support | Description |
|---|---|---|
| assuranceTargetList | M | This is an attribute containing a list of |
| | | name-value-pairs. The name of the |
| | | attribute which is part of a name- |
| | | value-pair in the AssuranceTargetList. |
| | | The assurance TargetName shall be equal |
| | | to the name of an attribute in the relevant |
| | | ServiceProfile or SliceProfile. The |
| | | relevant ServiceProfile or SliceProfile is |
| | | identified by the attribute serviceProfileId |
| | | or sliceProfileId in the |
| | | AssuranceGoal. The value of the attribute |
| | | which is part of a name-value-pair in the |
| | | AssuranceTargetList |
| sliceProfileId | CM | Identifier of the slice profile used to |
| | | derive the goals |
| serviceProfileId | CM | Identifier of the service profile used to |
| | | derive the goals |
| observationTime | M | It indicates the time duration over which |
| | | an AssuranceGoal is observed. The |
| | | observation time is expressed in seconds. |
| AssuranceGoalStatusObserved | O | It holds the status of the observed goal |
| | | fulfilment to the assuranceGoal. |
| | | allowedValues: “FULFILLED”, |
| | | “NOT_FULFILLED” |
| AssuranceGoalStatusPredicted | It holds the | It holds the status of the predicted future |
| | status of the | goal fulfilment to the assuranceGoal. |
| | predicted | |
| | future goal | |
| | fulfilment to | |
| | the assuranceGoal | |
| targetLocationInfo | O | Target location for the SLS (service |
| | | level specification) assurance. The |
| | | location can be defined as Cell IDs, |
| | | TAIs or PLMN ID. |
| >>targetUE | O | Target UE, with in the target location |
| | | identified by targetLocationInfo, for the |
| | | SLS assurance. |
| TargetUE | O | Target UE for the SLS assurance. |

In an embodiment, the monitoring module 208 may be configured to receive the input data 203 from the input module 207. Further, the monitoring module 208 may be configured to monitor the wireless communication network 102 based on the one or more assurance goals configured for the ACCL. Firstly, the monitoring module 208 may request measurement data for the at least one of, the one or more target locations and the one or more target UEs from the wireless communication network 102.

The measurement data may comprise values associated with one or more attributes of the wireless communication network 102. For example, the measurement data may comprise current throughput value, current latency value, current bandwidth value, and the like of a network slice used by the one or more target UEs in a target location. A person skilled in the art will appreciate that the one or more attributes may comprise other attributes such as status of network nodes, status of link connecting the network nodes, and the like, and is not limited to the above-mentioned attributes.

The monitoring module 208 may receive the measurement data associated with the one or more target locations and the one or more target UEs from the wireless communication network 102, based on the request. The monitoring module 208 may receive the measurement data from one or more network nodes of the wireless communication network 102. The measurement data may be stored as the monitoring data 204 in the memory 104.

In an embodiment, the determination module 209 may be configured to receive the input data 203 from the input module 207 and the monitoring data 204 from the monitoring module 208. Further, the determination module 209 may be configured to determine whether the one or more assurance goals are complied based on the monitoring. Particularly, the determination module 209 may compare the measurement data with the one or more assurance goals.

For example, consider that the measurement data comprises a current bandwidth of 800 Mbps. The one or more assurance goals may comprise a bandwidth value of 1000 Mbps. The determination module 209 may determine whether the one or more assurance goals are complied based on the comparison. In the above-stated example, the determination module 209 may determine that the one or more assurance goals are not complied since the current bandwidth value is less than the bandwidth value defined in the one or more assurance goals.

In another example, the measurement data may comprise the current latency value of 40 ms. The one or more assurance goals may comprise a maximum latency value of 50 ms. The determination module 209 may determine whether the one or more assurance goals are complied based on the comparison. In the above-stated example, the determination module 209 may determine that the one or more assurance goals are complied since the current latency value is within the maximum latency value defined in the one or more assurance goals.

The other data 206 may store data, including temporary data and temporary files, generated by the one or more modules 202 for performing the various functions of the ACCL system 101. The one or more modules 202 may also include the other modules 210 to perform various miscellaneous functionalities of the ACCL system 101.

For example, the other modules 210 may include a mitigation module. The mitigation module may be configured to perform one or more mitigation actions when the one or more assurance goals are not complied. In one embodiment, the mitigation module may perform the one or more mitigation actions. In another embodiment, the mitigation module may communicate the one or more mitigation actions to the ACCL consumer. The one or more mitigation actions, for example, may include decreasing maximum number of users allocated per slice, adding one or more network resources, and the like. The other data 206 may be stored in the memory 104. It will be appreciated that the one or more modules 210 may be represented as a single module or a combination of different modules.

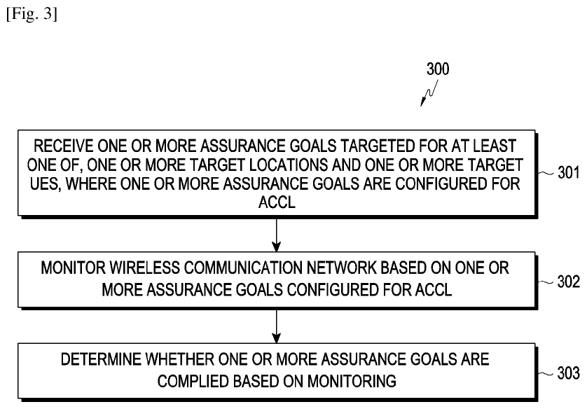

FIG. 3 shows an exemplary flow chart illustrating method steps for providing the wireless communication network assurance, in accordance with some embodiments of the present disclosure.

As illustrated in FIG. 3, the method 300 may comprise one or more steps. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 301, the ACCL system 101 may receive the one or more assurance goals targeted for at least one of, the one or more target locations and the one or more target UEs. The one or more assurance goals are received from the ACCL consumer. The one or more assurance goals may comprise one or more pre-defined attributes for the wireless communication network 102. In an embodiment, the one or more assurance goals may comprise desired values or threshold values associated with the one or more pre-defined attributes.

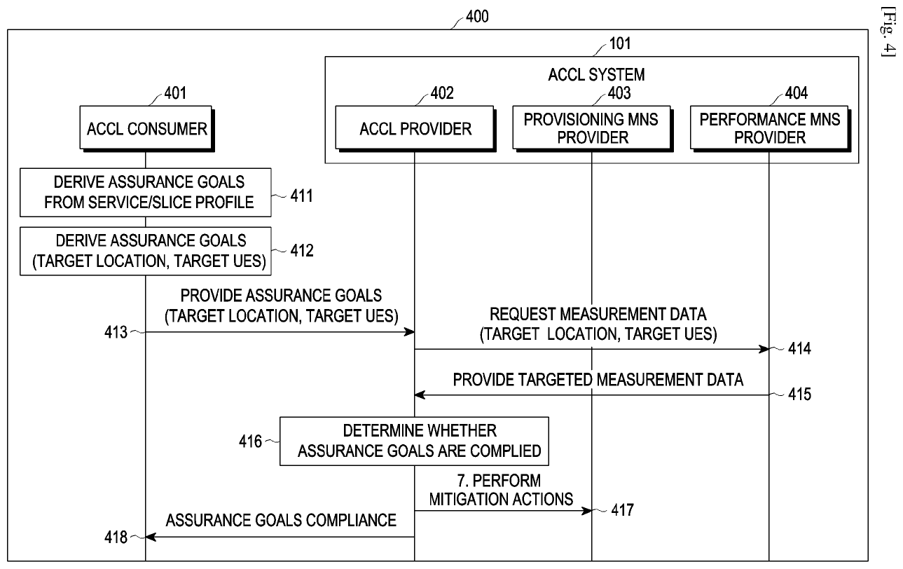

FIG. 4 shows an exemplary sequence diagram illustrating steps for providing the wireless communication network assurance, in accordance with some embodiments of the present disclosure.

Reference is made to FIG. 4 illustrating a sequence diagram 400 for providing the wireless communication network assurance. The sequence diagram 400 illustrates communication between ACCL consumer 401 and the ACCL system 101. In an embodiment, the ACCL consumer 401 and the ACCL system 101 may communicate over a communication network. The communication network may include, without limitation, generic provisioning management service as defined in 3GPP TS 28.532, a direct interconnection, local area network (LAN), wide area network (WAN), wireless network (e.g., using Wireless Application Protocol), the Internet, etc.

In another embodiment, the ACCL consumer 401 may be directly associated with the ACCL system 101. The ACCL system 101 comprises a ACCL provider 402, a Network Slice/Network Slice Subnet provisioning Management Service (MnS) provider 403 (referred as provisioning MnS provider 403 in FIG. 4), and a performance assurance MnS provider 404 (referred as performance MnS provider 404 in FIG. 4). Referring to step 411, the ACCL consumer 401 may identify/derive the one or more assurance goals from the service profile or slice profile. At step 412, the ACCL consumer 401 may identify/derive the one or more assurance goals for at least one of, the one or more target locations and the one or more target UEs. At step 413, the ACCL consumer 401 may provide the one or more assurance goals to the ACCL provider 402.

In an embodiment, at least one of the one or more assurance goals may indicate the target for assurance goal in terms of location. A ACCL may target for a particular location. The assurance goal status may be ascertained based on the appropriately collected performance measurements as per the target location. In an embodiment, at least one of the one or more assurance goals may include a cell ID, a tracking area identity (TAI), or public land mobile network (PLMN) ID that identifying tracking area of a network node related to a target location.

Referring back to FIG. 3, at step 302, the ACCL system 101 may monitor the wireless communication network 102 based on the one or more assurance goals configured for the ACCL. The ACCL system 101 may request measurement data for the at least one of, the one or more target locations and the one or more target UEs from the wireless communication network 102. Further, the ACCL system 101 may receive the measurement data associated with the one or more target locations and the one or more target UEs from the wireless communication network 102, based on the request.

Referring again to FIG. 4, at step 414, the ACCL provider 402 may request the measurement data from the performance assurance MnS provider 404. The performance assurance MnS provider 404 may collect the measurement data from the one or more network nodes of the wireless communication network 102. At step 415, the performance assurance MnS provider 404 may provide the measurement data for the at least one of, the one or more target locations and the one or more target UEs to the ACCL provider 402. In an embodiment, the performance assurance MnS provider 404 may stream the measurement data to the ACCL provider 402.

Referring back to FIG. 3, at step 303, the ACCL system 101 may determine whether the one or more assurance goals are complied based on the monitoring. Particularly, the ACCL system 101 may compare the measurement data with the one or more assurance goals. Further, the ACCL system 101 may determine whether the one or more assurance goals are complied based on the comparison.

Referring again to FIG. 4, at step 416, the ACCL provider 402 may determine whether the one or more assurance goals are complied based on the monitoring. In an embodiment, the ACCL system 101 may be configured to perform the one or more mitigation actions when the one or more assurance goals are not complied. Referring to the FIG. 4, at step 417, the ACCL provider 402 may communicate with the provisioning MnS provider 403 to perform the one or more mitigation actions. For example, the provisioning MnS provider 403 may provision one or more network resources in the wireless communication network 102. At step 418, the ACCL provider 402 may communicate regarding the compliance of the one or more assurance goals with the ACCL consumer 401.

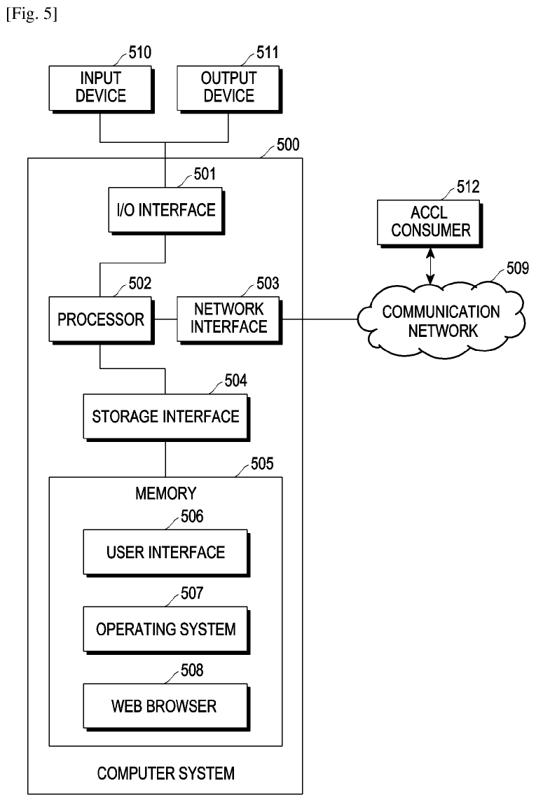

FIG. 5 illustrates a block diagram of an exemplary computer system 500 for implementing embodiments consistent with the present disclosure.

Referred to FIG. 5, the computer system 500 may be used to implement the ACCL system 101. Thus, the computer system 500 may be used for providing the wireless communication network assurance by receiving the one or more assurance goals from the ACCL consumer 512. The one or more assurance goals may be received from the ACCL consumer 512 over the communication network 509.

The computer system 500 may comprise a Central Processing Unit 502 (also referred as “CPU” or “processor”). The processor 502 may comprise at least one data processor. The processor 502 may include specialized processing units such as integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE (Institute of Electrical and Electronics Engineers) -1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices. For example, the input device 510 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 511 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The computer system 500 may communicate with the ACCL consumer 512 through a communication network 509. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 509 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507, web browser 508 etc. In some embodiments, computer system 500 may store user/application data, such as, the data, variables, records, etc., as described in this disclosure. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE MACINTOSHR OS X, UNIXR, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLER IOS™, GOOGLER ANDROID™, BLACKBERRYR OS, or the like.

In some embodiments, the computer system 500 may implement the web browser 508 stored program component. The web browser 508 may be a hypertext viewing application, for example MICROSOFTR INTERNET EXPLORER™, GOOGLER CHROMETMO, MOZILLAR FIREFOX™, APPLER SAFARI™, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX™, DHTML™, ADOBER FLASH™, JAVASCRIPT™, JAVA™, Application Programming Interfaces (APIs), etc.

In some embodiments, the computer system 500 may implement a mail server (not shown in Figure) stored program component. The mail server may be an Internet mail server such as Microsoft Exchange, or the like. The mail server may utilize facilities such as ASP™, ACTIVEX™, ANSI™ C++/C #, MICROSOFTR, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFTR exchange, Post Office Protocol (POP), Simple Mail Transfer Protocol (SMTP), or the like. In some embodiments, the computer system 500 may implement a mail client stored program component. The mail client (not shown in Figure) may be a mail viewing application, such as APPLER MAIL™, MICROSOFTR ENTOURAGE™, MICROSOFTR OUTLOOK™, MOZILLAR THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be nontransitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

Embodiments of the present disclosure enables deployment of the ACCL for a particular location. This allows targeted assurance in a particular location. For example, strict assurance for an enhanced Mobile Broadband (eMBB) service can be provided using the ACCL for a high-valued vertical customer present in a particular location. Further, the present disclosure enables deployment of the ACCL for a UE(s). This allows targeted assurance for a particular UE(s). For example, strict assurance for an eMBB service can be provided using the ACCL for a high-valued UE present in a particular location.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 and FIG. 4 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### REFERRAL NUMERALS

100 Exemplary environment
101 ACCL system
102 Wireless communication network
103 Processor
104 Memory
105 I/O interface
200 Detailed diagram
201 Data
202 Modules
203 Input data
204 Monitoring data
205 Determination data
206 Other data
207 Input module
208 Monitoring module
209 Determination module
210 Other modules
400 Sequence diagram
401 ACCL consumer
402 ACCL provider
403 Provisioning MnS provider
404 Performance MnS provider
500 Computer system
501 I/O interface
502 Processor
503 Network interface
504 Storage interface
505 Memory
506 User interface
507 Operating system
508 Web browser
509 Communication network
510 Input device
511 Output device
512 ACCL Consumer

1. A method of providing wireless communication network assurance, the method comprising:
receiving, by an assurance closed control loop (ACCL) system, one or more assurance goals targeted for at least one of, one or more target locations and one or more target user equipments (UEs), wherein the one or more assurance goals are configured for an ACCL;
monitoring, by the ACCL system, a wireless communication network based on the one or more assurance goals configured for the ACCL; and
determining, by the ACCL system, whether the one or more assurance goals are complied based on the monitoring.

2. The method as claimed in claim 1, wherein the one or more assurance goals are received from an ACCL consumer.

3. The method as claimed in claim 1, wherein the one or more assurance goals comprise one or more pre-defined attributes for the wireless communication network, and are derived from at least one of a service profile or a slice profile of the wireless communication network, and wherein the one or more target locations comprises at least one of a cell ID, a tracking area identity (TAI), or public land mobile network (PLMN) ID.

4. The method as claimed in claim 1, wherein monitoring the wireless communication network based on the one or more assurance goals, comprises:
requesting measurement data for the at least one of, the one or more target locations and the one or more target UEs from the wireless communication network; and
receiving the measurement data associated with the one or more target locations and the one or more target UEs from the wireless communication network, based on the request.

5. The method as claimed in claim 1, wherein determining whether the one or more assurance goals are complied comprises:
comparing measurement data with the one or more assurance goals; and
determining whether the one or more assurance goals are complied based on the comparison.

6. The method as claimed in claim 5, wherein the measurement data is associated with the at least one of, the one or more target locations and the one or more target UEs, and obtained from the wireless communication network.

7. The method as claimed in claim 1, further comprising performing one or more mitigation actions when the one or more assurance goals are not complied.

8. The method as claimed in claim 7, wherein the one or more mitigation actions includes at least one of: decreasing maximum number of users allocated per slice, or adding one or more network resources.

9. An assurance closed control loop (ACCL) system for providing wireless communication network assurance, the ACCL system comprising:
a processor; and
a memory storing processor executable instructions, which, on execution, causes the processor to:
receive one or more assurance goals targeted for at least one of, one or more target locations and one or more target user equipments (UEs), wherein the one or more assurance goals are configured for an ACCL;
monitor a wireless communication network based on the one or more assurance goals configured for the ACCL; and
determine whether the one or more assurance goals are complied based on the monitoring.

10. The ACCL system as claimed in claim 9, wherein the processor (103) receives the one or more assurance goals from an ACCL consumer.

11. The ACCL system as claimed in claim 9, wherein the one or more assurance goals comprise one or more pre-defined attributes for the wireless communication network and are derived from at least one of a service profile or a slice profile of the wireless communication network, and
wherein the one or more target locations comprises at least one of a cell ID, a tracking area identity (TAI), or public land mobile network (PLMN) ID.

12. The ACCL system as claimed in claim 9, wherein the processor (103) monitors the wireless communication network based on the one or more assurance goals by:
requesting measurement data for the at least one of, the one or more target locations and the one or more target UEs from the wireless communication network; and
receiving the measurement data associated with the one or more target locations and the one or more target UEs from the wireless communication network, based on the request.

13. The ACCL system as claimed in claim 9, wherein the processor determines whether the one or more assurance goals are complied by:
comparing measurement data with the one or more assurance goals; and
determining whether the one or more assurance goals are complied based on the comparison.

14. The ACCL system as claimed in claim 13, wherein the measurement data is associated with the at least one of, the one or more target locations and the one or more target UEs, and obtained from the wireless communication network.

15. The ACCL system as claimed in claim 9, wherein the processor is further configured to perform one or more mitigation actions when the one or more assurance goals are not complied, and
wherein the one or more mitigation actions includes at least one of: decreasing maximum number of users allocated per slice, or adding one or more network resources.
